(19) United States
(12) Patent Application Publication
(10) Pub. No.: US 2026/0042654 A1
(43) Pub. Date: Feb. 12, 2026

(54) SYSTEMS AND METHODS FOR CARBONATING AND DISPENSING A BEVERAGE

(71) Applicant: PepsiCo, Inc., Purchase, NY (US)

(72) Inventors: Matthew HARKINS, Bethel, CT (US); Steven JERSEY, Laguna Niguel, CA (US); Andrew POTTER, Cambridge (GB); Laura KIMPTON, Baldock (GB); Ross JONES, Cambridge (GB); Andrew TAYLOR, Cambridge (GB); Coco DAY, Cambridge (GB)

(21) Appl. No.: 18/797,101

(22) Filed: Aug. 7, 2024

(51) Int. Cl. B67D 1/00; B01F 23/236; B01F 23/237; B01F 23/2373; B01F 23/40; B01F 23/451; B01F 25/10; B01F 25/313; B01F 25/452; B01F 101/14

(52) U.S. Cl. CPC B67D 1/0058; B01F 23/2363; B01F 23/2373; B01F 23/237621; B01F 23/451; B01F 23/483; B01F 25/103; B01F 25/3131; B01F 25/3133; B01F 25/4522; B67D 1/0044; B01F 2101/14; B01F 2215/0431

(57) ABSTRACT

Embodiments disclosed herein are related to a dispenser system for dispensing carbonated beverages, including flavored carbonated beverages. The dispenser system can provide on-demand, in-line carbonation of beverages (i.e., without a holding tank). The dispenser system can be sized to fit on a countertop. The dispenser system can include a nozzle system that allows for in-nozzle mixing of carbonated water with a beverage ingredient (e.g., a syrup). The dispensers system can include a contactor that includes a sparge plate; a dissolution tube for dissolving carbon dioxide bubbles in water; a sparge disc for reducing pressure of the carbonated water to atmospheric pressure; a beverage ingredient source for providing an ingredient; and a nozzle that receives and mixes the carbonated water and the ingredient.

### BACKGROUND

The present disclosure relates to dispensers for dispensing a carbonated beverage. More specifically, the present disclosure relates to on-demand dispensers that carbonate a liquid in-line with microbubbles or nanobubbles of a gas (e.g., carbon dioxide). The dispensers can be countertop dispensers.

### BRIEF SUMMARY

Some embodiments are directed to a dispenser for dispensing a carbonated beverage. In some embodiments, the dispenser includes a contactor, a dissolution tube, a sparge disc, a beverage ingredient source, and a nozzle. In some embodiments, the contactor is disposed within the dispenser, the configured to receive water from a water source and receive carbon dioxide from a carbon dioxide source. In some embodiments, the contactor includes a sparge plate configured to generate carbon dioxide bubbles. In some embodiments, the sparge plate is configured to receive carbon dioxide at a rate of 1 gram to 10 grams carbon dioxide per liter of water flowing through the contactor. In some embodiments, the sparge disc configured to receive carbonated water from the dissolution tube. In some embodiments, the sparge disc is configured to reduce the pressure of the carbonated water to atmospheric pressure.

In any of the various embodiments described herein, the dissolution tube has a length of about 50 cm to about 500 cm.

In any of the various embodiments described herein, the sparge plate is configured to generate carbon dioxide bubbles having an average diameter of 100 μm or less.

In any of the various embodiments described herein, 100% of the carbon dioxide received from the carbon dioxide source is dissolved in the water.

In any of the various embodiments described herein, the sparge disc is configured to reduce the pressure of the carbonated water from a pressure of greater than or equal to 100 PSI to atmospheric pressure.

In any of the various embodiments described herein, the nozzle is configured to receive a beverage ingredient from the beverage ingredient source, and the nozzle is configured to mix the carbonated liquid and the beverage ingredient to create the carbonated beverage.

In any of the various embodiments described herein, the nozzle includes a hydrocyclone configured to mix the carbonated water with a beverage ingredient from the beverage ingredient source.

In any of the various embodiments described herein, the carbon dioxide source, the carbon dioxide source is disposed within the dispenser.

In any of the various embodiments described herein, the dispenser further includes the water source. In some embodiments, the water sources is disposed within the dispenser.

In any of the various embodiments described herein, the dispenser is a countertop dispenser. In any of the various embodiments described herein, the contactor, the carbon dioxide source, the water source, and the beverage ingredient source are each disposed within the dispenser.

Some embodiments are directed a nozzle system for dispensing a carbonated beverage. In some embodiments, the nozzle system includes a cap, a body, and a nozzle insert. In some embodiments, the cap includes a first inlet configured to receive carbonated water and a second inlet configured to receive a beverage ingredient. In some embodiments, the body includes an internal volume having a first diameter at a top end of the body and a second diameter below the first diameter. In some embodiments, the second diameter is smaller than the first diameter. In some embodiments, the body includes a recess disposed below second diameter. In some embodiments, the nozzle insert is configured to be at least partially inserted in the recess. In some embodiments, nozzle system is configured to mix the carbonated water and the beverage ingredient in the body to form a carbonated beverage. In some embodiments, the nozzle system has a flow path from the cap, through the body, and through the nozzle insert.

In any of the various embodiments described herein, the first inlet is oriented horizontally, and the second inlet is oriented vertically.

In any of the various embodiments described herein, the nozzle insert is configured to couple to the body at the recess by friction fit.

In any of the various embodiments described herein, the nozzle insert includes a wall configured to segment an interior volume of the nozzle insert.

In any of the various embodiments described herein, the cap is in fluid communication with a sparge disc that is configured reduce the pressure of the carbonated water to atmospheric pressure before the carbonated water flows through the first inlet.

In any of the various embodiments described herein, the nozzle system further includes a sparge assembly. In some embodiments, the sparge assembly includes the sparge disc and a sparge disc holder configured to receive the sparge disc.

In any of the various embodiments described herein, the second diameter is disposed about 70 mm to about 85 mm below the first diameter.

In any of the various embodiments described herein, the first diameter is about 2 to about 4 times larger than the second diameter.

In any of the various embodiments described herein, the first diameter is from about 25 mm to about 35 mm, and the second diameter is about 8 mm to about 12 mm.

In any of the various embodiments described herein, the first inlet is configured to receive a first hose that is in fluid communication with a contactor, and the second inlet is configured to receive a second hose that is in fluid communication with a beverage ingredient source.

Some embodiments are directed to a method of dispensing a carbonated beverage from a dispenser system. In some embodiments, the method includes receiving, on a user interface, a user input. In some embodiments, the method includes flowing carbon dioxide from a carbon dioxide source to a contactor. In some embodiments, the contactor includes a sparge plate. In some embodiments, the method includes flowing water from a water source to the contactor. In some embodiments, the method includes producing carbon dioxide bubbles in the contactor to create a mixture of water and carbon dioxide bubbles. In some embodiments, the method includes flowing the mixture through a dissolution tube to dissolve the carbon dioxide bubbles in the water to create carbonated water. In some embodiments, the method includes flowing the carbonated water and a beverage ingredient through a nozzle system. In some embodiments, the nozzle system include a sparge disc configured to reduce the pressure of the carbonated water to atmospheric pressure.

In any of the various embodiments described herein, the beverage ingredient flows through a first nozzle inlet oriented in a first direction, and the carbonated water flows through a second nozzle inlet oriented in a second direction that is perpendicular to the first direction.

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 illustrates a dispenser system according to some embodiments.

FIG. 2 illustrates a dispenser system according to some embodiments.

FIG. 3 illustrates a nozzle system according to some embodiments.

FIG. 4 is an exploded view of the nozzle system of FIG. 3.

FIG. 5 is a cross-sectional view of the nozzle system of FIG. 3 along line 3-3.

FIG. 6 is a cross-sectional view of the nozzle system of FIG. 3 along line 3-3 with a sparge assembly.

FIG. 7 is an exploded view of the sparge assembly shown in FIG. 6.

FIGS. 8A-8D illustrate nozzle inserts of the nozzle system of FIGS. 5-7.

FIG. 9 illustrates a method according to some embodiments.

### DETAILED DESCRIPTION

Carbonated beverages are often created by injecting carbon dioxide into a liquid. Often dispensers for dispensing carbonated beverages carbonate the beverages within the dispenser itself. However, these dispensers typically use thermal treatments (e.g., cooling) during carbonation. For example, because carbonation processes are enhanced at lower temperatures, existing methods require chilling a liquid pre- or post-carbonation. Otherwise, there is a limit to the about of carbonation possible if not chilled. This is because lower temperatures enable carbonation (i.e., the dissolution of carbon dioxide into a liquid) by ensuring the proper solubility needed for the product at required speeds. If the temperatures are too high, existing dispensers or processes do not allow for higher carbonation levels to be practical or economical.

Although carbonation processes related to large-scale beverage production may carbonate without requiring significant refrigeration, such processes cannot be easily scaled down to dispensers. Such systems often have dimensions far exceeding practical dimensions for a carbonated beverage dispenser. For example, such carbonation systems may have dimensions exceeding 1 to 2 meters and be used as part of a larger beverage production system and produce beverages at a rate on the order of hundreds of liters per minute.

Moreover, these existing large-scale systems operate at high pressures that are not compatible with beverage dispensers. And existing beverage dispensers typically do not include nozzles that can accommodate the high pressures of existing microbubble or ambient carbonation systems.

Additionally, existing methods and system are not able to achieve high dissolution rates without adding excess carbon dioxide to the liquid. This results in significant amounts of wasted carbon dioxide during the carbonation process, and can result in inconsistent product quality.

Embodiments described herein overcome these and other challenges by providing-among other benefits-systems and methods for dispensing carbonated beverages at ambient temperatures and at atmospheric pressure. For example, embodiments described herein use smaller bubble sizes to increase dissolution rate and enable room temperature carbonation. For example, bubbles may be microbubbles or nanobubbles. Embodiments described herein allow for non-thermal carbonation of liquid without adversely affecting the attributes of the resulting carbonated beverage (e.g., taste, color, shelf life, etc.). Embodiments described herein can also improve the consistency of the end product and reduce wasted carbon dioxide by allowing a complete dissolution approach to carbonation. In some embodiments, the benefits are all provided by a self-contained beverage dispenser. For example, in some embodiments, the beverage dispenser is a countertop dispenser.

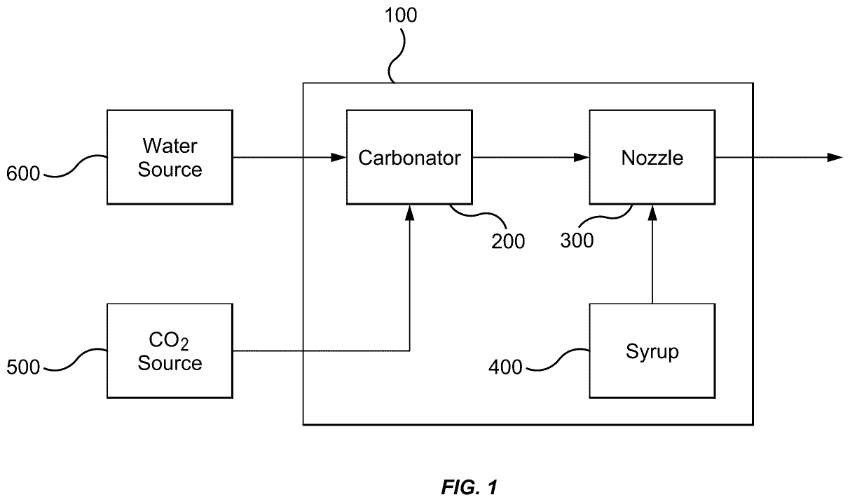

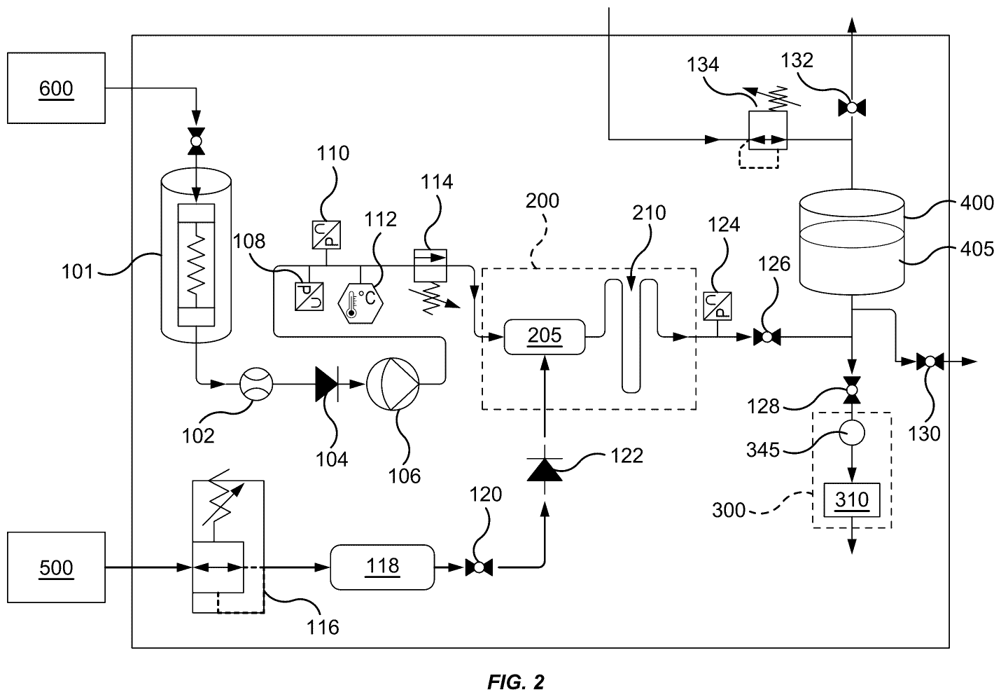

As shown in FIGS. 1 and 2, dispenser system 100 can include carbonation system 200, nozzle system 300, and ingredient source 400. Carbonation system 200 can be coupled to carbon dioxide source 500 and/or water source 500. In some embodiments, carbon dioxide source 500 is outside of dispenser system 100. In some embodiments, carbon dioxide source 500 is inside of dispenser system 100.

In some embodiments, carbonation system 200 includes contactor 205 and dissolution pipe 210. Contactor 205 can include components combining the water and carbon dioxide. For example, the carbonation system 200 can receive carbon dioxide from carbon dioxide carbon dioxide source 500 and water from water source 600. In some embodiments, carbonation system 200 pumps water and carbon dioxide into contactor 205 at high pressure.

Contactor 205 can include a sparge for adding the carbon dioxide to the water. In some embodiments, the sparge is a sparge plate that creates microbubbles in the water. The carbon dioxide can pass through the sparge plate and into fast flowing water. This creates microbubbles that are ripped from the sparge plate before they grow larger. These microbubbles then dissolve in the water.

In some embodiments, the sparge plate is a flat rectangular sparge plate. In some embodiments, the sparge plate has length from about 5 mm to about 20 mm and a width from about 50 mm to about 300 mm. In some embodiments, the length of the sparge plate is from about 5 mm to about 20 mm, from about 7 mm to about 15 mm, from about 10 mm to about 12 mm, or within a range having any two of these values as endpoints. In some embodiments, the sparge plate has a length of about 10 mm. In some embodiments, the sparge plate has a width from about 50 mm to about 300 mm, from about 100 mm to about 250 mm, from about 125 mm to about 200 mm, from about 150 mm to about 175 mm, or within a range having any two of these values as endpoints. In some embodiments, the sparge plate has a width of about 150 mm.

The sparge plate can include pores disposed on at least a portion of the sparge through which the carbon dioxide flows. The sparge plate can have a pore size of about 0.1 μm to about 2 μm, from about 0.2 μm to about 1.5 μm, from about 0.3 μm to about 1 μm, from about 0.4 μm to about 0.6 μm, or within a range having any two of these values as endpoints. In some embodiments, the sparge plate has a pore size of about 0.5 μm.

Carbonation system 200 can include dissolution tube 210 where the gas dissolves after the water and gas flow through contactor 205. As illustrated in FIG. 2, can be a relatively long tube that fluidly couples contactor 205 to nozzle system 300. Dissolution tube 210 can have varying lengths, for example from about 50 cm to about 500 cm. In some embodiments, dissolution tube 210 can have a length from about 50 cm to about 500 cm, from about 100 cm to about 300 cm, from about 100 cm to about 400 cm, from about 200 cm to about 300 cm, or within a range having any two of these values as endpoints. In some embodiments, dissolution tube 210 has a length of about 100 cm. In some embodiments, dissolution tube 210 has a length of about 300 cm.

Dissolution tube 210 can be made of various materials, for example plastic or metal. Dissolution tube 210 can be flexible or rigid. In some embodiments, dissolution tube 210 is a flexible plastic tube. In some embodiments, dissolution tube 210 is a metal pipe. In some embodiments, dissolution tube 210 is a machined tube formed in a block. Dissolution tube 210 can be wound or bent to provide a relatively long length while taking up a small amount of space in dispenser system 100. Although gas may tend to get trapped in bends of pipes, because of the operating pressure and flow rates of embodiments disclosed here no gas gets trapped in any bends of dissolution tube 210.

Although chilled water may be provided to carbonation system 200, carbonation system 200 can operate at ambient air temperatures. In other words, in some embodiments, the carbonation system 200 in dispenser system 100 is not refrigerated or chilled. As used herein, ambient air temperature is the temperature of the environment in which dispenser system 100 is located. In some embodiments, ambient air temperature is from about 15° C. to about 25° C.

Carbonation system 200 can produce carbonated water with microbubbles at high efficiency rates and at concentration levels suitable for various types of beverages, including carbonated colas, sparkling waters, etc. In some embodiments, carbonation system 200 can provide carbonation at 100% efficiency up to 10 grams carbon dioxide per liter.

The carbonation amount can be measured in grams carbon dioxide per liter of water (g/L). Carbonation system 200 can carbonate water to carbonation levels from about 3 g/L to about 11 g/L, from about 4 g/L to about 10.5 g/L, from about 4.5 g/L to about 10 g/L, from about 5 g/L to about 9.5 g/L, from about 5.5 g/L to about 9 g/L, from about 6 g/L to about 8 g/L, from about 6.5 g/L to about 7 g/L, or within a range having any two of these values as endpoints.

The dissolution efficiency can be the measured amount of pre-dispense carbonation as a percentage of the calculated amount of pre-dispense carbonation expected based on the amount of gas flow rate and water flow rate through carbonation system 200. For example, a dissolution efficiency of 100% means all carbon dioxide provided to carbonation system 200 is dissolved in the water, and a dissolution efficiency of 90% means 90% of the carbon dioxide provided to carbonation system 200 is dissolved in the water. In some embodiments, carbonation system 200 can achieve a dissolution efficiency of at least about 85% (e.g., at least 90% or at least 95%) at carbonation levels up to about 11 g/L. In some embodiments, carbonation system 200 can achieve a dissolution efficiency of 100% at carbonation levels up to about 9.8 g/L.

In some embodiments, contactor 205 and dissolution tube 210 together have a compact shape and size. For example, in some embodiments, contactor 205 and dissolution tube 210 together have a height less than or equal to about 200 mm (e.g., less than or equal to about 150 mm), a width less than or equal to about 75 mm (e.g., less than or equal to about 50 mm), and a length less than or equal to about 75 mm (e.g., less than or equal to about 50 mm). In some embodiments, contactor 205 and dissolution tube 210 together have a height less than or equal to 150 mm, a width less than or equal to 50 mm, and a length less than or equal to 50 mm.

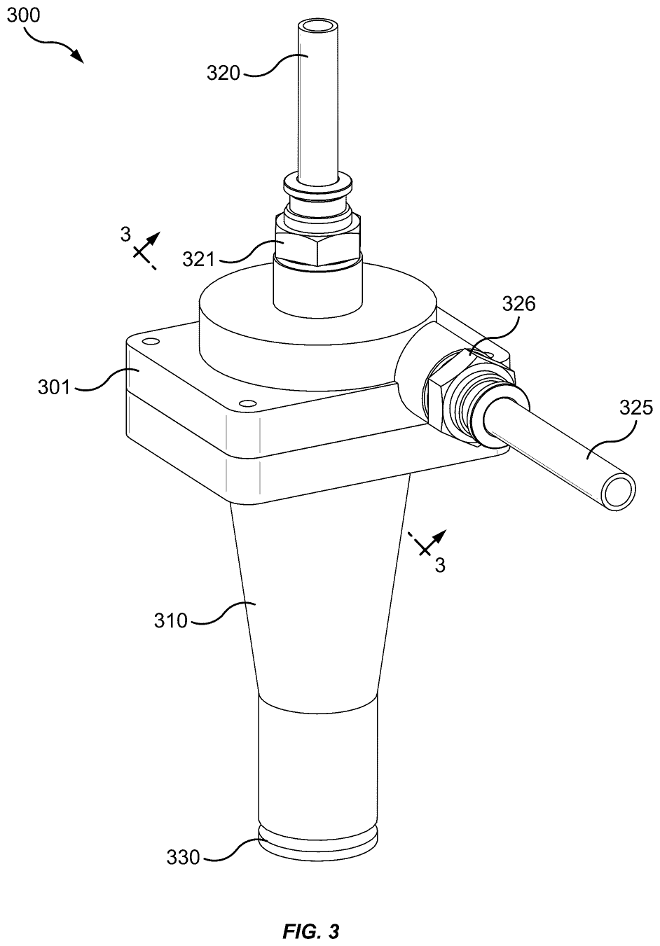

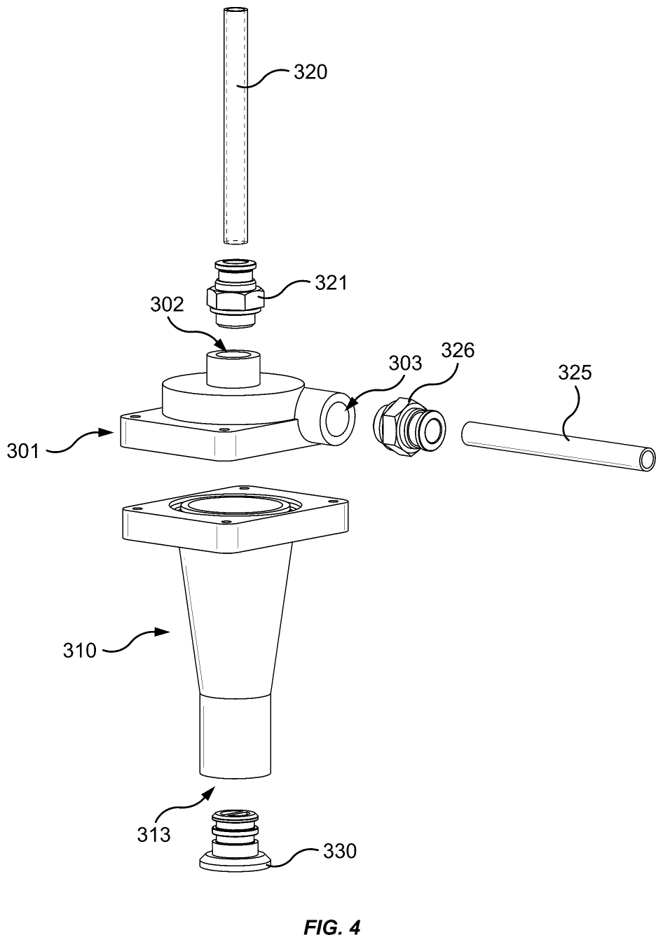

Dispenser system 100 can include nozzle system 300 through which a carbonated beverage is dispensed. FIGS. 3-6 illustrate nozzle system 300 according to some embodiments. FIG. 3 illustrates a perspective view of nozzle system 300, and FIG. 4 illustrates an exploded view of nozzle system 300 shown in FIG. 3. In some embodiments, nozzle system 300 can include cap 301, body 310, tube 320, fastener 321, tube 325, and fastener 326.

Nozzle system 300 can receive carbonated water from carbonation system 200 and a beverage ingredient from ingredient source 400, for example, through inlet 303 and inlet 302, respectively. Nozzle system 300 can be fluidly coupled to carbonation system 200 and to ingredient source 400. Ingredient source can include a fluid tank 405. In some embodiments, fluid tank 405 is a pressurized tank.

In some embodiments, nozzle system 300 is fluidly coupled to ingredient source 400 through tube 320. In some embodiments, tube 320 is coupled to inlet 302 by fastener 321. In some embodiments, nozzle system 300 is fluidly coupled to carbonation system 200 through tube 325. In some embodiments, tube 325 is coupled to inlet 303 by fastener 326.

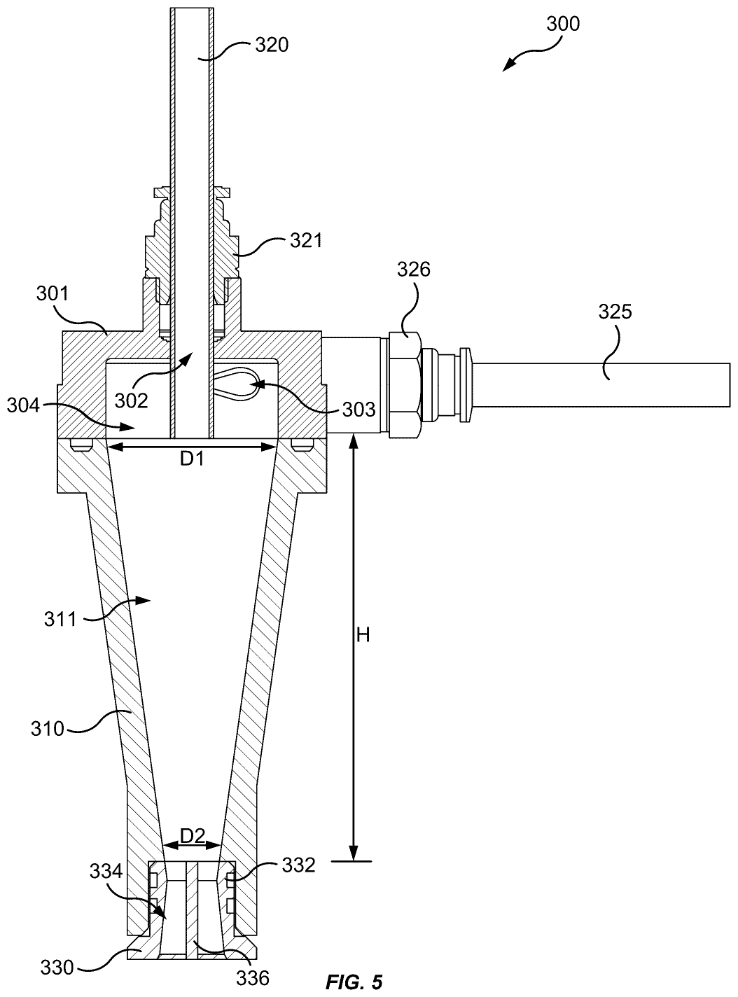

Nozzle system 300 can include a cap 301, body 310, and nozzle insert 330. As shown in FIGS. 3-5, cap 301 can include inlet 302 and inlet 303 and body 310 can have a conical shape. In some embodiments, cap 301 and body 310 form a hydrocyclone structure. FIG. 5 shows a cross-sectional view of nozzle system 300 along line 3-3. In some embodiments, cap 301 couples to body 310 at a top portion of body 310. Body 310 can include an outlet 312 disposed at a bottom end of body 310.

As shown in FIG. 5, in some embodiments, cap 301 includes internal volume 304 and body 310 includes interior volume 311. In some embodiments, interior volume 311 has a first diameter D1 at a top end of interior volume 311 and a second diameter D2 at a bottom end of interior volume 311. As shown in FIG. 5, in some embodiments, D1 is larger than D2 such that interior volume 311 has a conical shape. In some embodiments, D1 is about 1 times to about 5 times larger than D2. In some embodiments, D1 is from about 1 times to about 4 times larger than D2, from about 2 to about 4 times larger than D2, from about 3 times to about 3.5 times larger than D2, or within a range having any two of these values as endpoints. In some embodiments, D1 is about 3.2 times larger than D2. In some embodiments, D1 is from about 20 mm to about 40 mm, from about 25 mm to about 35 mm, from about 30 mm to about 35 mm, or within a range having any two of these values as endpoints. In some embodiments, D1 is about 32 mm. In some embodiments, D2 is from about 4 mm to about 16 mm, from about 6 mm to about 14 mm, from about 8 mm to about 12 mm, or within a range having any two of these values as endpoints. In some embodiments, D2 is about 10 mm.

As shown in FIG. 5, interior volume 311 can include a height H. In some embodiments, H is from about 50 mm to about 100 mm, from about 60 mm to about 90 mm, from about 70 mm to about 85 mm, from about 75 mm to about 80 mm, or within a range having any two of these values as endpoints. In some embodiments, H is about 78.5 mm.

The carbonated water from carbonation system 200 can be mixed with the beverage ingredient from ingredient source 400 inside body 310. In some embodiments, tube 320 extends through inlet 302 and into internal volume 304. As shown in FIG. 5, tube 320 and is oriented vertically such that beverage ingredients flow substantially vertically into body 310 of nozzle system 300. As shown in FIG. 5 inlet 303 and tube 325 can be oriented horizontally. In some embodiments, carbonated water flows horizontally through inlet 303 into cap 301. The shape of internal volume 304 and 311 will create conical flow of the carbonated water as it flows through inlet 303. The beverage ingredient can flow downwards at a center of interior volume 311. This flow pattern mixes the carbonated beverage and the beverage ingredient. This flow pattern and structure of body 310 can produce a well-mixed, uniformly flowing mixture of the carbonated water and the beverage ingredient. In some embodiments, the carbonated beverage has a uniform appearance. As used herein, “uniform appearance” means the carbonated beverage has a uniform color, consistency, and flavor during the entire dispensing cycle. This is a benefit over existing nozzles, which often do not fully mix the components inside of the nozzle. Additionally, this structure allows for very accurate dosing of a beverage ingredient (e.g., a syrup) into the carbonated water.

Another benefit of the structure of nozzle system 300 is a reduction in carbon dioxide loss. For example, in some embodiments, cap 301 and body 310 form a hydrocyclone, which reduces carbonation loss by separating escaped carbon dioxide bubbles before they grow. In some embodiments, the nozzle system 300 can reduce carbon dioxide loss such that carbonation system 200 can achieve at least 3.6 gas volumes of carbon dioxide in solution. These benefits contributed to the efficiencies that allow for systems disclosed herein to be scaled down to dispenser size, for example countertop dispenser size.

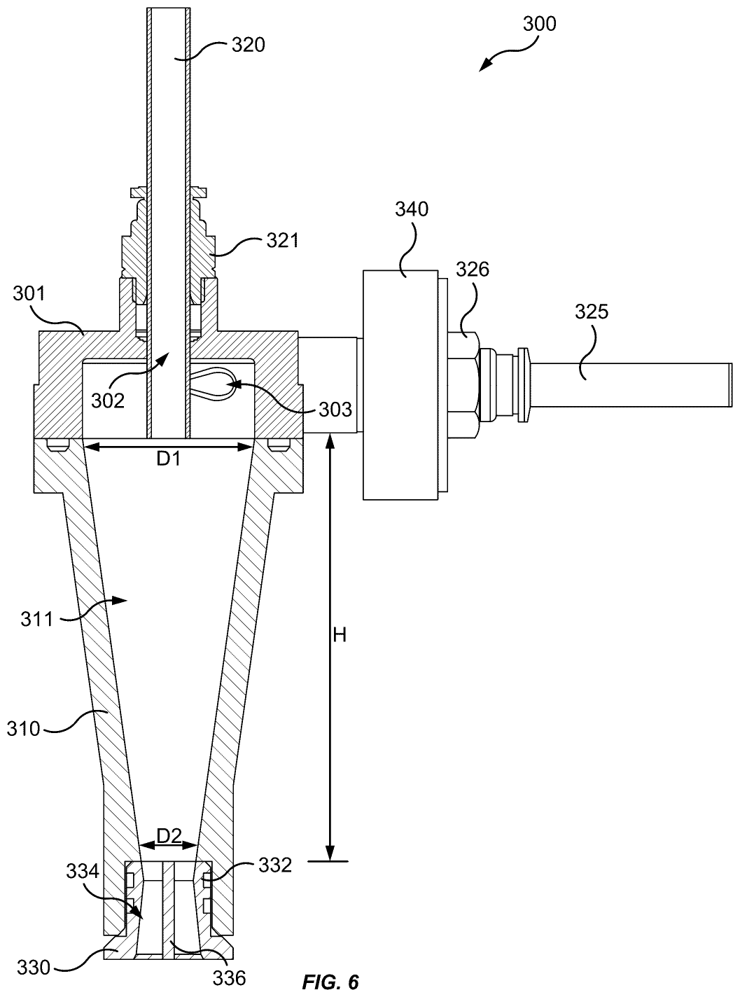

Nozzle system 300 can include a sparge assembly 340, as shown in FIGS. 6 and 7, that can reduce the pressure of the carbonated water exiting carbonation system 200. In some embodiments, sparge assembly 340 can reduce the pressure of water exiting carbonation system 200 to atmospheric pressure. In some embodiments, carbonated water is pumped (e.g., by a pump) from carbonation system 200 to sparge assembly 340 of nozzle system 300. In some embodiments, sparge assembly 340 includes holder 341, sparge disc 345, and adapter 344. FIG. 7 illustrates an exploded view of sparge assembly 340. As shown in FIG. 6, sparge assembly 340 can be disposed between inlet 303 and carbonation system 200.

In some embodiments, holder 341 includes protrusion 342 for coupling holder 341 to inlet 303. In some embodiments, holder 341 includes recess 343 for receiving sparge disc 345. In some embodiments, recess 343 can receive at least a portion of adapter 344 such that sparge disc 345 is surrounded by recess 343 and adapter 344. Adapter 344 can be coupled to tube 325 by fastener 326.

Sparge disc 345 may consist of pores disposed on at least part of sparge disc 345 through which gas flows. Sparge disc 345 can have varying sizes and pore sizes, which can affect the flow rate and the pressure of carbonated water flowing into nozzle. This is illustrated in Example 1.

In some embodiments, sparge disc 345 has a diameter from about 20 mm to about 50 mm, from about 25 mm to about 45 mm, from about 30 mm to about 40 mm, from about 45 mm to about 30 mm to about 38 mm, or within a range having any two of these values as endpoints. In some embodiments, D2 is about 10 mm. In some embodiments, sparge disc 345 has a pore size from about 8 μm to about 30 μm, from about 12 μm to about 25 μm, from about 15 μm to about 20 μm, or within a range having any two of these values as endpoints.

In some embodiments, sparge disc 345 has a diameter from about 25 mm to about 35 mm and a pore size from about 8 μm to about 12 μm. In some embodiments, sparge disc 345 has a diameter of about 30 mm and a pore size of about 10 μm.

In some embodiments, sparge disc 345 has a diameter from about 20 mm to about 30 mm and a pore size from about 20 μm to about 30 μm. In some embodiments, sparge disc 345 has a diameter of about 25 mm and a pore size of about 25 μm.

Nozzle system 300 can include nozzle insert 330 that can be inserted in recess 313 of body 310. As discussed above, the shape of internal volume 304 and 311 will create conical flow of the carbonated water as it flows through inlet 303, which can be beneficial for mixing and creating a uniform carbonated beverage. However, such conical flow can create splashing and spills if the conical flow is not eliminated before dispensing the carbonated beverage into a container. Nozzle insert 330 can eliminate the conical flow, creating a smoothly dispensing carbonated beverage.

Nozzle insert 330 can include outer wall 332 and interior volume 334 through which the carbonated beverage can flow. Additionally, nozzle insert 330 can include one or more walls 336 and/or fins 338 extending into interior volume 334. For example, nozzle insert 330 can include 1 or more (e.g., 2 or more, 3 or more, 4 or more, 5 or more, 6 or more, 7 or more, or 8 or more) walls 336 that segment interior volume 334. Additionally, nozzle insert 330 can include 1 or more (e.g., 2 or more, 3 or more, 4 or more, 5 or more, 6 or more, 7 or more, or 8 or more) fins 338 that extend partially into interior volume 334 but do not segment interior volume 334.

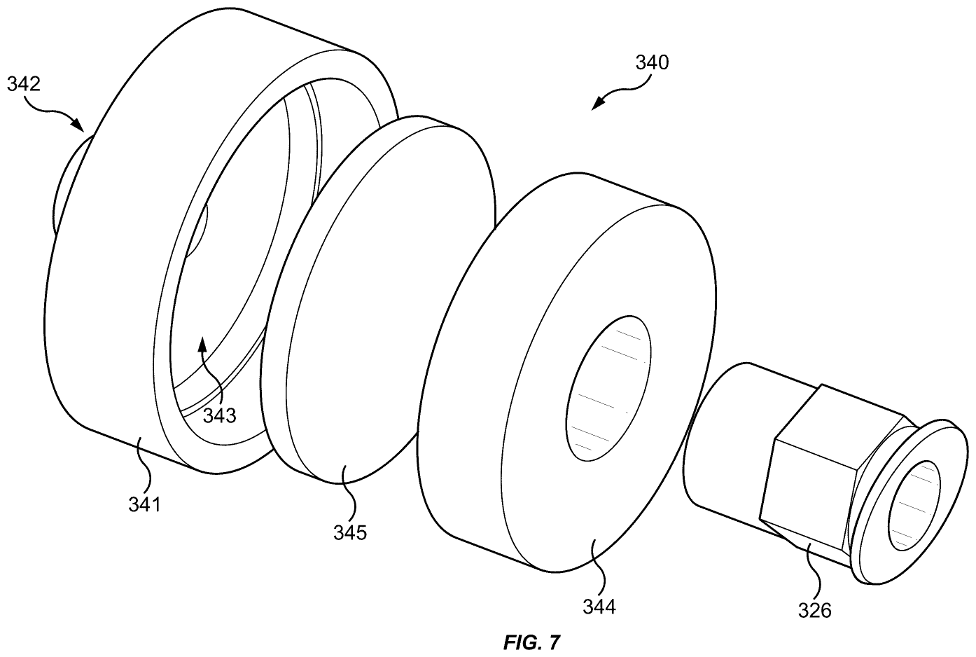

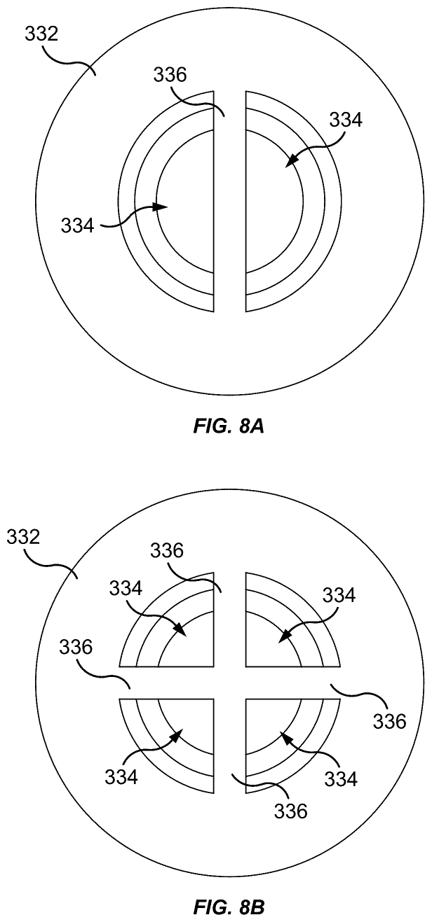

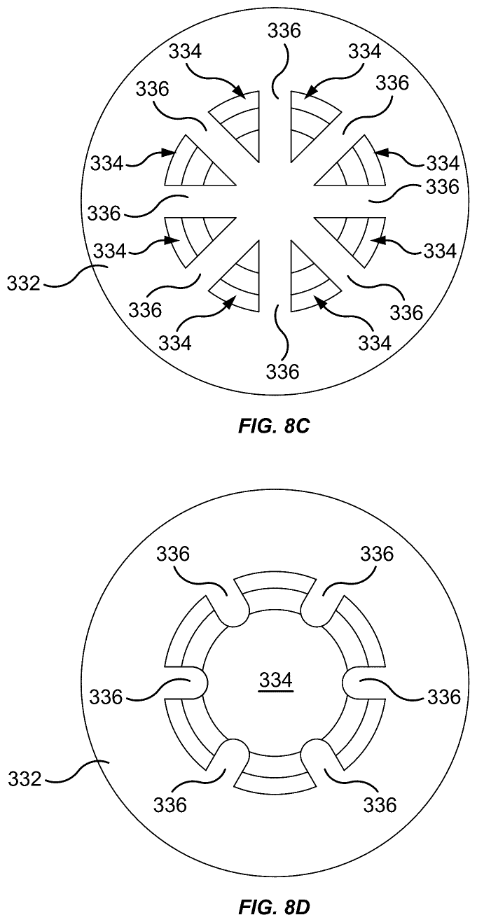

In some embodiments, as shown in FIGS. 5, 6, and 8A, nozzle insert 330 can include one wall 336 that separates internal volume 334 into two segments. In some embodiments, as shown in FIG. 8B, nozzle insert 330 can include four walls 336 that separate internal volume 334 into four segments. In some embodiments, as shown in FIG. 8C, nozzle insert 330 can include 8 walls 336 that separate internal volume 334 into 8 segments. In some embodiments, as shown in FIG. 8D, nozzle insert 330 can include 6 fins 338 extending into interior volume 334. Nozzle insert 330 can include a mix of walls 336 and fins 338.

Dispenser system 100 can include an ingredient source 400. In some embodiments, ingredient source 400 can provide an ingredient to nozzle system 300 to mix with carbonated water from carbonation system 200. In some embodiments, the ingredient may include syrups, flavors, vitamins, electrolytes, energy boosters, minerals, or combinations thereof. In some embodiments, ingredient source 400 can be pressurized. For example, ingredient source 400 can include 1 or more (e.g., 2 or more) solenoids to pressurize and vent ingredient source 400. In some embodiments, a control system controls the pressure of the ingredient source 400.

Dispenser system 100 can include a user interface (e.g., a display, buttons, etc.) that can be used to adjust the amount of ingredient provided by ingredient source 400. For example, in some embodiments, dispenser system 100 can adjust the amount of ingredient provided in response to receiving a user input. In some embodiments, a control system can be used to adjust the amount of the ingredient provided by ingredient source 400 to nozzle system 300.

In some embodiments, ingredients from ingredient source 400 can be provided to nozzle system 300 at a rate from 0 mL/s to about 4 mL/s. In some embodiments, the ingredient is provided at a rate of about 0 mL/s (i.e., no ingredients are added to the carbonated water). In some embodiments, the ingredient is provided at a rate from about 0.5 mL/s to about 4 mL/s, from about 1 mL/s to about 3.5 mL/s, from about 1.5 mL/s to about 2.5 mL/s, or within a range having any two of these values as endpoints.

In some embodiments, ingredient source 400 can include multiple different ingredients that can be added to the carbonated water. In some embodiments, ingredient source 400 provides ingredients at different rates depending on the concentration of the ingredient and/or the user's desired strength of the beverage. For example, in some embodiments, the rate at which the ingredient is provided to nozzle system 300 can be changed in response to a user input.

Carbon dioxide can be provided to carbonation system 200 from carbon dioxide source 500. In some embodiments, carbon dioxide source 500 is a gas canister disposed within dispenser system 100. In some embodiments, carbon dioxide source 500 is disposed outside of dispenser system 100 and flows into dispenser system 100 through piping (i.e., there are no carbon dioxide storage vessels in the dispenser system 100).

Water can be provided to carbonation system 200 from water source 600. In some embodiments, water source 600 is a reservoir disposed within dispenser system 100. In some embodiments, the reservoir is removably coupled to the dispenser system 100, for example to allow refilling of the reservoir. In some embodiments, dispenser system 100 is coupled to pluming such that water is provided to dispenser system 100 directly from a building's plumbing system.

Dispenser system 100 may have a compact and self-contained design such that dispenser system 100 can sit on a countertop, or be attached to a stand (e.g., a pedestal). Dispenser system 100 can be a countertop dispenser with all necessary components disposed within dispenser system 100. For example, in some embodiments, carbonation system 200, nozzle system 300, beverage ingredient source 400, carbon dioxide source 500, and water source 600 are all self-contained within dispenser system 100. In some embodiments, dispenser system 100 includes a housing, and carbonation system 200, nozzle system 300, beverage ingredient source 400, carbon dioxide source 500, and water source 600 are all self-contained within the housing of the dispenser system 100. For example, in some embodiments, these components are all self-contained in a single housing. In some embodiments, carbon dioxide source 500 and/or water source 600 are disposed outside of dispenser system 100 and are fluidly coupled to dispenser system 100.

For example, dispenser system 100 may have a width from about 12 inches to about 36 inches (e.g., from about 18 inches to about 24 inches). In some embodiments, dispenser system 100 may have a depth from about 12 inches to about 24 inches (e.g. from about 18 inches to about 24 inches). In some embodiments, dispenser system 100 may have a height from about 12 inches to about 24 inches (e.g., from about 15 inches to about 18 inches). In some embodiments, dispenser system 100 has a width of less than about 24 inches, a depth of less than about 24 inches, and a height of less than about 18 inches).

Dispenser system 100 can include various other components, as shown in FIG. 2. For example, dispenser system 100 can include chiller system 101, flowmeter 102; valves 104, 114, 120, 122, 126, 128, 130, 132; pump 106; pressure sensors 108, 110, 124; temperature sensor 112; carbon dioxide regulator 116; flow controller 118; and vent regulator 134.

In some embodiments, chiller system 101 receives water from water source 600 and chills the water before the water is pumped to carbonation system 200. In some embodiments, chiller system 101 chills water to a temperature in a range from about 0° C. to about 20° C., from about 2° C. to about 18° C., from about 6° C. t about 16° C., from about 8° C. to about 14° C., or about 10° C. to about 12° C., or within a range having any two of these values as endpoints. In some embodiments, chiller system 101 chills water to a temperature of about 2° C. In some embodiments, chiller system 101 chills water to a temperature of about 8° C. In some embodiments, chiller system 101 chills water to a temperature of about 14° C.

In some embodiments, dispenser system 100 does not include chiller system 101 and the water is provided to carbonation system 200 at ambient water temperatures. For example, carbonating at ambient water temperature can mean carbonating water at its incoming water temperature, without heating or cooling. Further, carbonating at ambient water temperature can mean carbonating at the dew point of the environment where carbonation occurs. In some embodiments, ambient water temperature is from about 4° C. to about 32° C. In some embodiments, carbonation system 200 carbonates liquid without thermal treatment. In some embodiments, carbonation system 200 carbonates liquid at ambient water temperature and without thermal treatment. In some embodiments, carbonation system 200 carbonates liquid without heating and without cooling the liquid. In some embodiments, carbonation system 200 carbonates liquid at a temperature from about 4° C. to about 30° C., from about 4° C. to about 20° C., from about 10° C. to about 30° C., from about 10° C. to about 20° C., from about 15° C. to about 30° C., from about 18° C. to about 28° C., from about 20° C. to about 25° C., or within a range having any two of these values as endpoints.

In some embodiments, flowmeter 102 measures the flow rate of water from water source 600 and/or chiller system 101. In some embodiments, pressure sensors 108, 110, and 124 measure the pressure of various fluids flowing through dispenser system 100. In some embodiments, temperature sensor 112 measures the temperature of water flowing from chiller system 101 to carbonation system 200.

In some embodiments, valves 104, 114, 120, 122, 126, 128, 130, and 132 can control the flow of various components through dispenser system 100. In some embodiments, valves 104 and 122 are check valves that prevent backflow of fluid. For example, valve 104 can prevent backflow of water moving from water source 600 to carbonation system 200, and valve 122 can prevent backflow of carbon dioxide flowing from carbon dioxide source 500 to carbonation system 200. In some embodiments, valve 114 is a pressure relief valve to relieve pressure of the water flowing from pump 106 to carbonation system 200. For example, if the pressure in the line from pump 106 to carbonation system 200 exceeds a predetermined threshold, valve 114 can open to relieve pressure. In some embodiments, valve 120 can be used to turn off flow of carbon dioxide from carbon dioxide source 500 to carbonation system 200. In some embodiments, valve 120 is a ball valve. In some embodiments, valves 126, 128, 130, and 132 are solenoid valves. In some embodiments, valve 132 is used to vent system 100. In some embodiments, vent regulator 134 is used to regulate airflow into ingredient source 400.

In some embodiments, pump 106 can pressurize water flowing from water source 600 and/or chiller system 101 to carbonation system 200. In some embodiments, pump 106 can pressurize water to a pressure from about 50 psi to about 250 psi, from about 70 psi to about 175 psi, from about 80 psi from about 160 psi, from 90 psi to about 150 psi, from about 100 to about 110 psi, or within a range having any two of these values as endpoints. In some embodiments, the water is pressurized to a range from about 50 psi to about 250 psi. In some embodiments, the water is pressurized to a range from about 90 psi to about 110 psi. In some embodiments, the water is pressurized to a range of about 100 psi.

In some embodiments, flow controller 118 can control the pressure and flow rate of carbon dioxide from carbon dioxide source 500 to carbonation system 200. In some embodiments, flow controller 118 can provide carbon dioxide at a pressure from about 50 psi to about 120 psi, from about 60 psi to about 100 psi, from about 70 psi to about 80 psi, or within a range having any two of these values as endpoints. In some embodiments, the carbon dioxide flows at a pressure from about 60 psi to about 80 psi. In some embodiments, flow controller 118 can provide carbon dioxide at a flow rate from about 8 g/min to about 50 g/min, from about 10 g/min to about 40 g/min, from about 12 g/min to about 35 g/min, from about 15 g/min to about 30 g/min, from about 20 g/min to about 25 g/min, or within a range having any two of these values as endpoints.

Dispenser system 100 can be an on-demand, in-line carbonation system, meaning there is no holding tank for holding the carbonated beverage before dispensing. Dispenser system 100 can be configured to dispense varying amounts of carbonated beverage while maintaining consistent carbonation levels. For example, in some embodiments, dispenser system 100 is configured to dispense from about 60 mL to about 2000 mL while maintaining the desired carbonation levels (e.g., the carbonation levels discussed above).

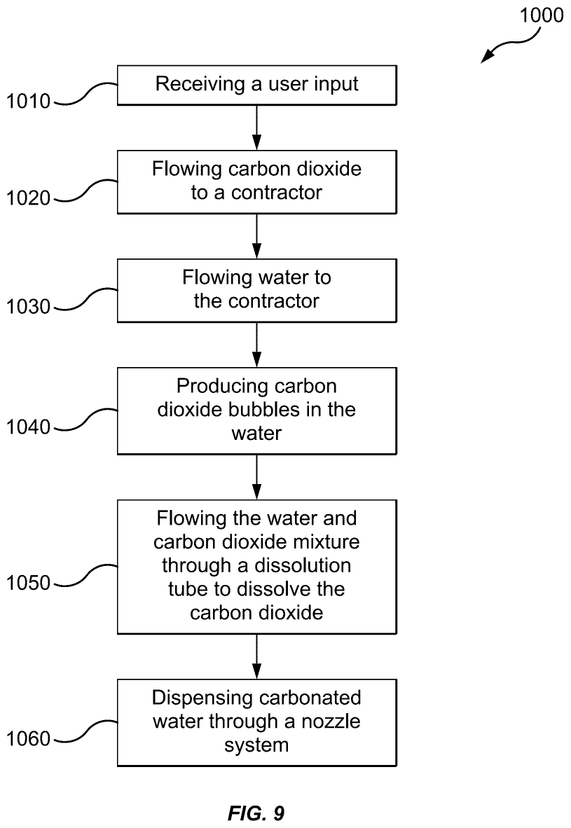

FIG. 9 is a flow chart of an exemplary method 1000 of using systems disclosed herein. Method 1000 can include receiving a user input at step 1010. In some embodiments, the user input is received on a user interface (e.g., a display, buttons, etc.). Method 1000 can include flowing carbon dioxide to a contactor at step 1020. In some embodiments, carbon dioxide is flowed from carbon dioxide source 500 to contactor 205. Method 1000 can include flowing water to a contactor at step 1030. In some embodiments, water is flowed from water source 600 to contactor 205. Method 1000 can include producing carbon dioxide bubbles in the water in the contactor at step 1040. In some embodiments, microbubbles are produced by contactor 205. Method 1000 can include flowing the water and carbon dioxide mixture through a dissolution tube to dissolve the carbon dioxide in the water at step 1050. Method 1000 can include dispensing carbonated water through a nozzle system at step 1060. In some embodiments, the carbonated water is dispensed through nozzle 300. In some embodiments, carbonated water is mixed with an ingredient (e.g., from ingredient source 400) in nozzle system 300.

### EXAMPLES

### Example 1

In one experiment, various sparge discs were used in systems disclosed herein to test for pressure, flow rate, and in-cup carbonation. The sparge discs had varying diameters and pore sizes. The results are shown in Table 1 below. Each sparge disc was tested at a gas flow rate of 1700 gram/hr and at a water temperature of approximately 8°

TABLE 1

| | Sparge disc | Sparge | | | In-cup |
|---|---|---|---|---|---|
| | diameter | disc pore | Pressure | Flow rate | carbonation |
| Sparge | (mm) | size (μm) | (bar) | (L/min) | (gram/L) |
| A | 38 | 15 | 3.7 | 3.6 | 4.35 |
| B | 30 | 25 | 3.1 | 3.5 | 4.37 |
| C | 30 | 10 | 4.5 | 3.4 | 4.51 |
| D | 25 | 25 | 8.2 | 2.7 | 5.03 |
| E | 20 | 25 | 10.2 | 2.2 | n/a |
| F | 16 | 60 | 10 | 2 | n/a |

As shown above, sparge discs A-D achieved in-cup carbonation in excess of 4.3 gram/L. The in-cup carbonation for sparge discs E and F were not measured. This was because the pressure was too high, resulting in stalling of the pump that pumped carbonated water to the sparge discs.

### Example 2

Sparge discs A-D described in Example 1 were tested for in-cup carbonation rates and average retention rates at various temperatures, dispense time, and gas flow rates. The average retention rate is the percentage of carbon dioxide retained during dispensing. For example, a retention of 60% means 60% of the carbon dioxide added to water by the carbonator (e.g., carbonation system 200) remains through dispensing and in-cup. Each test except test #8 was run in three times, and the values in Table 2 below show the averages of the three runs. Test #8 was run twice, and the values in Table 2 show the averages of the two runs. Sparge discs E and F were not tested because of the pressure-stalling issue identified in Example A. In this experiment, the tests were carried out at the gas flow rates, water temperatures, and dispense times shown in Table 2 below.

TABLE 2

| | | | | | In-cup | Average |
|---|---|---|---|---|---|---|
| | | Temp. | Dispense | Gas rate | carbonation | retention |
| Test | Sparge | (° C.) | time (s) | (gram/hr) | (gram/L) | (%) |
| A1 | A | 8 | 5 | 1700 | 4.35 | 60 |
| A2 | B | 8 | 5 | 1700 | 4.37 | 60 |
| A3 | C | 8 | 5 | 1700 | 4.51 | 59 |
| A4 | D | 8 | 5 | 1700 | 5.03 | 52 |
| A5 | C | 2 | 5 | 1700 | 5.10 | 64 |
| A6 | C | 2 | 5 | 2100 | 5.57 | 56 |
| A7 | C | 2 | 2 | 2000 | 5.24 | 64 |
| A8 | D | 2 | 15 | 1700 | 6.69 | 60 |

As shown in Table 2, in-cup carbonation in excess of 4.3 grams was achieved for all tests, and average retention greater than 50% was achieved for all tests.

### Example 3

In one experiment, carbonation rates were tested using various dissolution tube lengths, residence times, and gas rates. In this experiment, water was pumped to a bladder-pressurized tank to measure pre-dispense carbonation. The residence time shown in Table 3 is how long the system was run into the tank (i.e., it correlates with how much water was carbonated). The water temperature used in this experiment was 14° C.

TABLE 3

| | | | | Pre- | |
|---|---|---|---|---|---|
| | Dissolution | | | dispense | Dissolution |
| | tube length | Residence | Gas rate | carbonation | efficiency |
| Test | (cm) | time (s) | (gram/hr) | (gram/L) | (%) |
| B1 | 100 | 15 | 600 | 3.25 | 100 |
| B2 | 100 | 15 | 600 | 3.29 | 100 |
| B3 | 100 | 15 | 600 | 3.28 | 100 |
| B4 | 100 | 15 | 1200 | 6.02 | 100 |
| B5 | 100 | 15 | 1200 | 6.33 | 100 |
| B6 | 100 | 15 | 1200 | 6.34 | 100 |
| B7 | 100 | 15 | 1200 | 6.28 | 100 |
| B8 | 300 | 15 | 1800 | 9.49 | 99.61 |
| B9 | 300 | 15 | 1800 | 9.64 | 99.00 |
| B10 | 300 | 15 | 1800 | 9.60 | 98.42 |
| B11 | 300 | 15 | 2000 | 10.5 | 89.07 |
| B12 | 300 | 15 | 2000 | 10.9 | 89.43 |
| B13 | 300 | 15 | 2000 | 10.7 | 93.67 |
| B14 | 300 | 15 | 2000 | 10.5 | 91.98 |
| B15 | 300 | 15 | 1200 | 6.63 | 98.57 |
| B16 | 300 | 15 | 1800 | 10.3 | 94.01 |
| B17 | 300 | 15 | 1700 | 10.6 | 97.94 |
| B18 | 300 | 15 | 1700 | 10.5 | 99.83 |
| B19 | 300 | 5 | 1800 | 8.34 | 92.44 |
| B20 | 300 | 5 | 1800 | 8.89 | 98.60 |
| B21 | 300 | 5 | 1800 | 9.17 | 100 |
| B22 | 300 | 45 | 1700 | 9.43 | 100 |
| B23 | 300 | 45 | 1700 | 9.63 | 100 |
| B24 | 300 | 45 | 1700 | 9.78 | 100 |

As shown in Table C, high dissolution efficiencies were achieved at various dissolution pipe lengths, residence times, and flow rates. For example, pre-dispense carbonation from about 3 gram/L to about 11 gram/L can be achieved with greater than 89% dissolution efficiency. Indeed, pre-dispense carbonation from about 3 gram/L to about 9.8 gram/L was achieved with 100% dissolution efficiency.

Further, as shown by Table 3, there is not a significant difference in dissolution across different residence times. This indicates that the dispenser can provide consistent carbonation levels when dispensing varying volumes of the carbonated beverage.

As used herein, the terms “upper” and “lower,” and “top” and “bottom,” and the like are intended to assist in understanding of embodiments of the disclosure with reference to the accompanying drawings with respect to the orientation of dispenser system 100 or components therein as shown, and are not intended to be limiting to the scope of the disclosure or to limit the disclosure scope to the embodiments depicted in the Figures. The directional terms are used for convenience of description and it is understood that dispenser system 100 and components therein may be positioned in any of various orientations.

As used herein, when the term “about” is used in describing a value or an end-point of a range, the disclosure should be understood to include the specific value or end-point referred to. As used herein, the term “about” may include ±10%.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present disclosure should not be limited by any of the above-described exemplary embodiments, but should be defined only in accordance with the claims and their equivalents.

What is claimed is:

1. A dispenser for dispensing a carbonated beverage, the dispenser comprising:
a contactor disposed within the dispenser, the contactor configured to receive water from a water source and receive carbon dioxide from a carbon dioxide source, the contactor comprising:
a sparge plate configured to generate carbon dioxide bubbles, and wherein the sparge plate is configured to receive carbon dioxide at a rate of 1 gram to 10 grams carbon dioxide per liter of water flowing through the contactor;
a dissolution tube;
a sparge disc configured to receive carbonated water from the dissolution tube, wherein the sparge disc is configured to reduce the pressure of the carbonated water to atmospheric pressure;
a beverage ingredient source; and
a nozzle for dispensing the carbonated beverage.

2. The dispenser of claim 1, wherein the dissolution tube has a length of about 50 cm to about 500 cm.

3. The dispenser of claim 1, wherein the sparge plate is configured to generate carbon dioxide bubbles having an average diameter of 100 μm or less.

4. The dispenser of claim 1, wherein 100% of the carbon dioxide received from the carbon dioxide source is dissolved in the water.

5. The dispenser of claim 1, wherein the sparge disc is configured to reduce the pressure of the carbonated water from a pressure of greater than or equal to 100 PSI to atmospheric pressure.

6. The dispenser of claim 1, wherein the nozzle is configured to receive a beverage ingredient from the beverage ingredient source, and
wherein the nozzle is configured to mix the carbonated liquid and the beverage ingredient to create the carbonated beverage.

7. The dispenser of claim 1, wherein the nozzle comprises a hydrocyclone configured to mix the carbonated water with a beverage ingredient from the beverage ingredient source.

8. The dispenser of claim 1, further comprising the carbon dioxide source, wherein the carbon dioxide source is disposed within the dispenser.

9. The dispenser of claim 1, further comprising the water source, wherein the water sources is disposed within the dispenser.

10. The dispenser of claim 1, wherein the dispenser is a countertop dispenser, and wherein the contactor, the carbon dioxide source, the water source, and the beverage ingredient source are each disposed within the dispenser.

11. A nozzle system for dispensing a carbonated beverage, the nozzle system comprising:
a cap, the cap comprising:
a first inlet configured to receive carbonated water; and
a second inlet configured to receive a beverage ingredient;
a body, the body comprising:
an internal volume, the internal volume having a first diameter at a top end of the body and a second diameter below the first diameter, wherein the second diameter is smaller than the first diameter; and
a recess disposed below second diameter; and
an nozzle insert configured to be at least partially inserted in the recess
wherein the nozzle system is configured to mix the carbonated water and the beverage ingredient in the body to form a carbonated beverage,
wherein the nozzle system has a flow path from the cap, through the body, and through the nozzle insert.

12. The nozzle system of claim 11, wherein the first inlet is oriented horizontally, and
wherein the second inlet is oriented vertically.

13. The nozzle system of claim 11, wherein the nozzle insert is configured to couple to the body at the recess by friction fit.

14. The nozzle system of claim 11, wherein the nozzle insert comprises a wall configured to segment an interior volume of the nozzle insert.

15. The nozzle system of claim 11, wherein the cap is in fluid communication with a sparge disc that is configured reduce the pressure of the carbonated water to atmospheric pressure before the carbonated water flows through the first inlet.

16. The nozzle system of claim 15, further comprising a sparge assembly, the sparge assembly comprising:
the sparge disc; and
a sparge disc holder configured to receive the sparge disc.

17. The nozzle system of claim 11, wherein the second diameter is disposed about 70 mm to about 85 mm below the first diameter.

18. The nozzle system of claim 11, wherein the first diameter is about 2 to about 4 times larger than the second diameter.

19. The nozzle system of claim 11, wherein the first diameter is from about 25 mm to about 35 mm, and wherein the second diameter is about 8 mm to about 12 mm.

20. The nozzle system of claim 11, wherein the first inlet is configured to receive a first hose that is in fluid communication with a contactor, and
wherein the second inlet is configured to receive a second hose that is in fluid communication with a beverage ingredient source.

21. A method of dispensing a carbonated beverage from a dispenser system, the method comprising:
receiving, on a user interface, a user input;
flowing carbon dioxide from a carbon dioxide source to a contactor, the contactor comprising a sparge plate;
flowing water from a water source to the contactor;
producing carbon dioxide bubbles in the contactor to create a mixture of water and carbon dioxide bubbles;
flowing the mixture through a dissolution tube to dissolve the carbon dioxide bubbles in the water to create carbonated water;
flowing the carbonated water and a beverage ingredient through a nozzle system, the nozzle system comprising a sparge disc configured to reduce the pressure of the carbonated water to atmospheric pressure.

22. The method of claim 21, wherein the beverage ingredient flows through a first nozzle inlet oriented in a first direction, and wherein the carbonated water flows through a second nozzle inlet oriented in a second direction that is perpendicular to the first direction.
